(19) United States
(12) Patent Application Publication
(10) Pub. No.: US 2004/0070679 A1
(43) Pub. Date: Apr. 15, 2004

(54) Compensating for delays inherent in digital still camera imaging

(76) Inventor: David R. Pope, Milpitas, CA (US)

Correspondence Address: NOTARO AND MICHALOS, 100 DUTCH HILL ROAD, SUITE 110, ORANGEBURG, NY, 10962-2100, US

(21) Appl. No.: 10/271,089

(22) Filed: Oct. 15, 2002

(51) Int. Cl. H04N 5/76

(52) U.S. Cl. 348/231.99

(57) ABSTRACT

The delays in digital still cameras due to the lag between the press of the shutter release and the shutter opening and due to the reaction time of the photographer are compensated for by continuously capturing and storing images and by selecting a desired one of the images based on the lags. Upon processing an indication from the photographer, the camera begins capturing images at regular images and stores the most recent images in a first-in first-out buffer. At a second indication from the photographer, the camera selects, in accordance with the lags, the image in the buffer a fixed amount of time prior to the second indication for further processing. In this way, both the delay due to human reaction time and the delay due to shutter lag have been compensated for.

### BACKGROUND OF THE INVENTION

1. Field of the Invention

This invention relates to the field of electronic still imaging, and more particularly, to compensating for the delay between the moment a photographer wants to capture and when the digital camera actually captures the image.

2. The Related Art

In electronic still imaging, it is very difficult to time photographs correctly. When attempting to take a photograph of a fleeting moment, such as the smile of a small child, the image that is captured is often too late. The moment has passed before the shutter opens.

The timing error is due primarily to two delays in the still imaging system. The first is the human reaction time—the time between when the child smiles and when the shutter release is actuated. The second delay, specific to digital cameras, is the delay between when the shutter release is actuated and when the shutter opens. This delay is due to the processing a digital camera must perform prior to taking a picture. The result of these delays is that the moment captured is later in time than the desired moment.

Two methods are commonly employed to compensate for the inherent delays, both of which have serious drawbacks. The first is to take multiple shots as fast as the camera is capable of until a buffer memory in which the images so taken are stored is full. Then the camera stops acquiring additional images until the images in the buffer are processed and saved to a long-term memory. The technique has two drawbacks. First, the moment that the photographer desires to capture may come after the buffer has filled and the shot is simply missed. Second, many more images than are necessary are stored in long-term storage which both fills up the long-term storage and requires manual selection and determination of which is the correct image to keep.

The second method of compensating for the inherent delays is called “streaming snapshot”. Images are captured rapidly at regular intervals, processed and stored to a long-term storage. Again, there are several drawbacks to this method. The images stored are typically of much lower resolution than normal digital images taken with the same camera to keep processing times fast enough to capture the next image. The long-term storage quickly fills up if the desired moment does not arrive shortly, and the task of finding the desired photograph is tedious.

### SUMMARY OF THE INVENTION

Thus, an object of the present invention is to provide a method for compensation of inherent delay of digital still camera.

Another object of the present invention is to provide a camera embodying the method of the present invention to enable users of digital still cameras to capture the moment they intend to capture when they trigger the shutter release.

The objects are achieved by providing a method for controlling the operation of a digital camera. The operation of the digital camera includes generation of an indication when a photographer has framed a basic image to his or her satisfaction. In response to the indication, the camera performs all processing necessary to take the picture, which includes at least autofocus (if the camera is autofocus) and exposure settings. When the processing is completed, the camera begins to capture still images at a constant frame rate, for example ten frames per second.

In a best mode of the method of the present invention, the still images that are captured and not processed are stored in a buffer memory of the camera in a first-in first-out manner. The number of images that are stored in the buffer memory depends on average reaction time of photographers—the time between when a child achieves the perfect smile and when the photographer physically presses the shutter release button. A typical example of the reaction time is 300 ms, in which case the buffer must store at least four images captured at ten frames per second. When the buffer contains four images and another image is captured, the oldest image is removed from the storage to make room for the new image. This prevents the system from running out of storage space.

When the photographer indicates his or her desire to capture the image, which is approximately 300 ms (the reaction time) after the moment he or she wanted to capture, the camera stops taking the images at the constant frame rate. The image taken closest in time to 300 ms prior to the indication from the photographer is retained in the buffer memory and all other images are deleted. The remaining image is then processed the same as any other digital still image captured by the camera would be. Both the delay due to human reaction time and the delay due to shutter lag are compensated for.

An advantage of the present invention is that it eliminates shutter delays yet does not require major changes to the existing designs of digital cameras. It corrects for both human reaction time and the camera processing time without placing excessive demands on the storage or processing units of the camera.

A detailed explanation of the best mode of the present invention will be given, with reference to the attached drawings, for better understanding thereof to those skilled in the. In the drawings:

### BRIEF DESCRIPTION OF THE DRAWINGS

FIG. 1 is a block diagram of a digital still camera embodying the present invention;

FIG. 2 is a flow chart of a method for compensating inherent delays of the digital still camera in accordance with the present invention; and

FIG. 3 is a flow chart of determination of images to be kept in accordance with the present invention.

### DETAILED DESCRIPTION OF THE BEST MODE FOR CARRYING OUT THE PRESENT INVENTION

An overview of the architecture of a digital still camera will be given first before the present invention is explained in detail. Electronic still cameras employing area image sensors, such as Charge Coupled Device (CCD) or Complementary Metal-Oxide Semiconductor (CMOS), are well known. The description is therefore directed in particular to the elements involved in, or cooperating more directly with, the operation of a digital camera performing a method in accordance with the present invention. Elements not specifically shown or described herein may be selected from those known in the art and details thereof will not be given.

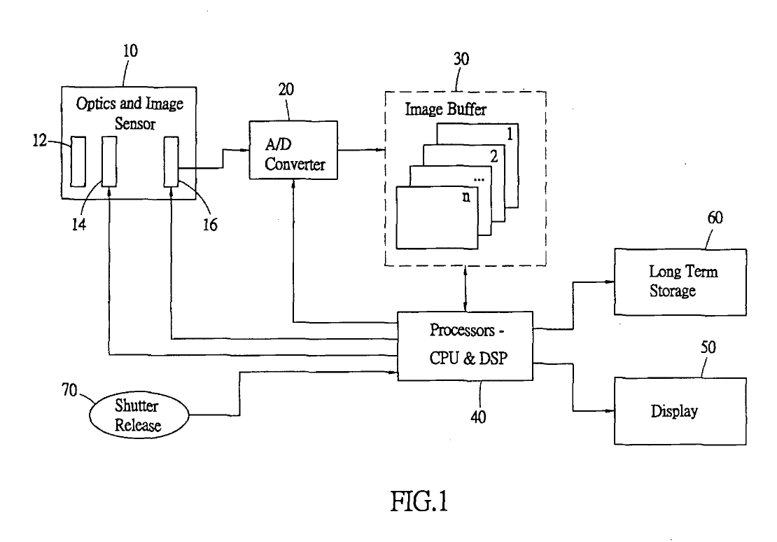

Referring to the drawings and in particular to FIG. 1, an electronic still camera comprises generally an optics and image sensor section 10 for directing image light from a subject (not shown) toward an image sensor 16. The optics and image sensor section 10 comprises optics 12 that may be conventional and known to those having ordinary skills in the art for directing the image light through a diaphragm, which regulates the optical aperture, and a shutter, which regulates exposure time. Together, the diaphragm and shutter are broadly designated with reference numeral 14. In the embodiment illustrated, the sensor 16 is a two-dimensional array of photosites corresponding to picture elements of an image of the subject. Typically it is either a charge-coupled device (CCD) or complementary metal-oxide semiconductor (CMOS) sensor using either well known interline transfer or frame transfer techniques. The sensor 16 is exposed to image light so that analog image charge information is generated in respective photosites. The analog image signals are typically applied to an analog-to-digital (A/D) converter 20, which generates a digital image signal from the analog input signal for each picture element. The A/D converter 20 can be located on the same chip as the sensor and each pixel can have its own A/D converter.

The digital signals generated by the A/D converter 20 are applied to an image buffer 30, which, in the embodiment illustrated, is a random access memory (RAM) with storage capacity for at least one still image. The image buffer 30 allows the image stored therein to be processed at a rate slower than it is read off of the image sensor 16.

A processor unit 40 generally controls the camera by initiating and controlling exposure (by operation of the diaphragm and shutter 14), by generating the necessary timing signals, and by controlling the flow of image information. The processor unit 40 includes a microprocessor coupled with both a system timing circuit and a digital signal processor (DSP). The processor unit 40 initiates an image capture in response to a press of a shutter release button 70 by a user of the digital still camera. Often the shutter release 70 is a two-stage switch. Pressing a button of the shutter release 70 half way (the first stage) instructs the camera to perform in advance as many necessary operations as possible, including, but not limited to, auto-focus and exposure determination. Pressing the button all the way (second stage) indicates that the user wants to capture an image. When this indication is received, the processor unit 40 performs computations or functions and initiates the exposure.

Once the digital image has been stored in the image buffer 30, the image information is processed to maximize image quality, compressed and saved in a long-term storage. The long-term storage is used by the camera to store images until the user wishes to remove the images from the camera. A most commonly used example of the long-term storage is a removable non-volatile memory card or alternatively a disk drive, either removable or fixed, a non-removable non-volatile memory, a volatile memory that is continually powered, or any other form of storage capable of holding the digital images until the user moves the images to another location can be employed.

The typical digital camera described above works well for taking pictures of stationary objects or posed photographs. It does not work as well for action shots or pictures of fleeting moments such as the brief smile of a small child. Most often the image captured by the camera is after the moment intended by the photographer. In many instances, this can be the difference between a great picture and a worthless one. There are two primary reasons for the difference in time between the moment in time the photographer desires to capture and the one that is captured. The first is due to the camera and the second is due to the photographer.

The first reason for the time difference is the delay between when the shutter release 70 is pressed and when the image is captured. There is a delay even if the photographer pressed a two-stage shutter release 70 half way prior to pressing it all the way, although it is much shorter. The processor must perform several operations before the shutter opens. This delay, which will be referred to as machine lag, can be very short, around two hundred milliseconds, but this can be significant.

The second reason for the time difference is the delay between the moment the photographer wants to capture and when the shutter release button 70 is actually pressed. This is because no human being can respond instantly and there is always a finite reaction time. The typical minimum reaction time to press a button when an expected signal appears is about 200 ms. If any form of decision is required, the reaction time goes up. Reaction times are typically about 300 ms or more for a simple decision and button press response. Such a reaction will be referred to as photographer's lag hereinafter.

In accordance with the present invention, a method is provided to compensate for both machine lag and photographer's lag and allows the photographer to capture the desired moment. An explanation, illustrative but not limitative, will be given for illustration of the present invention.

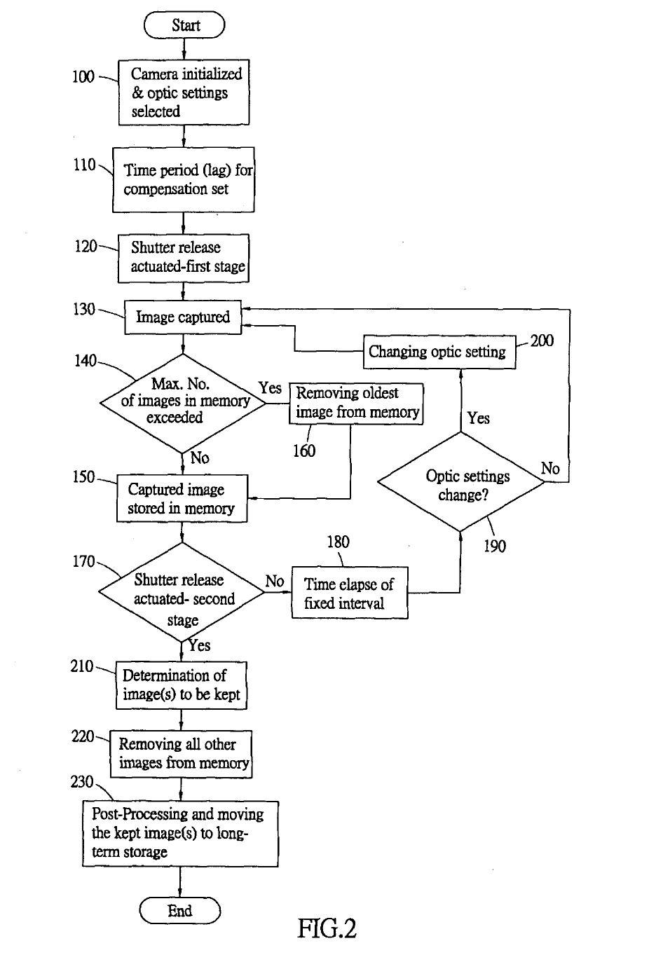

Referring to FIGS. 1 and 2, to operate a digital camera, the photographer selects a special mode on the camera in which the present invention is embodied. To practice the present invention in the special mode, several typical functions of the digital camera are altered. The first change is to the two-stage shutter release button. The camera is turned on and an initialization process is performed to get the camera ready, step 100. A time period for compensation of the photographer's lag is selected, step 110. The time period for compensation can be automatically set to be for example 300 ms as mentioned previously. Alternatively, the photographer can set the time period manually, based on the photographer's own practice.

The photographer presses the shutter release button 70 half way (the first stage of a two-stage shutter release), step 120, to indicate the scene is framed in the desired manner and that they are waiting for the correct instant to capture the image. At this point, the processor unit 40 performs all pre-processing required and begins capturing images at a constant rate (step 130). The constant rate can be changed, but a rate of ten frames per second is a good and practical choice. In other words, the camera is allowed to continuously take pictures after each time elapse of fixed interval of one-tenth seconds (because the images are taken at a rate of ten frames per second). The interval can be manually set by the photographer, but is not shown in the flow chart of FIG. 2.

Each raw image, prior to any processing, is written into the temporary buffer memory 30 (step 150) in a first-in, first-out (FIFO) manner. Before the image is written to the buffer memory 30, the buffer memory 30 is checked first, step 140, to determine if a maximum number of images that are stored in the buffer memory 30 is exceeded. The maximum number of images can be determined based on the photographer's lag (that is the time period for compensation). For example, when the number of images stored in the buffer is great enough that the difference in time between the oldest stored image and the newest previously stored image is greater than the photographer's lag, the oldest image is deleted (step 160) as each new image is captured and moved to the buffer (step 150), otherwise the newly captured image is written directly to the buffer memory 30 (step 150). In this way, the amount of buffer memory necessary remains fixed and relatively small, yet allows the fixed rate capture to continue indefinitely. The size of the buffer memory 30 must be great enough to store this number of images. Since volatile RAM is relatively cheap, there should not be a problem as the number of images is not that great.

As mentioned previously, the images are repeatedly taken after each time interval (step 180) if the shutter release 70 is not actuated to the second stage (step 170). In accordance with a variation of the present invention, the exposure and focus settings are allowed to change for the next shots. This is done by checking if the change is allowed, step 190. If the change is not allowed, the settings remain fixed for all of the subsequent images otherwise, if the processes are fast enough a new exposure and/or focus setting can be set for each subsequent image, step 200.

The photographer presses the shutter release 70 all the way (second stage) to indicate they want a final image captured. This indication comes the photographer's lag after the actual moment desired due to the reaction time discussed earlier. The processor unit 40 determines and selects the shot among the images stored in the buffer memory 30 that was captured closest in time to the photographer's lag prior to the full shutter release press, step 210, and deletes and removes all others, step 220. The selected image that remains in the buffer memory 30 is then post-processed by the camera as any other normal captured image would be and stored in long-term storage, step 230.

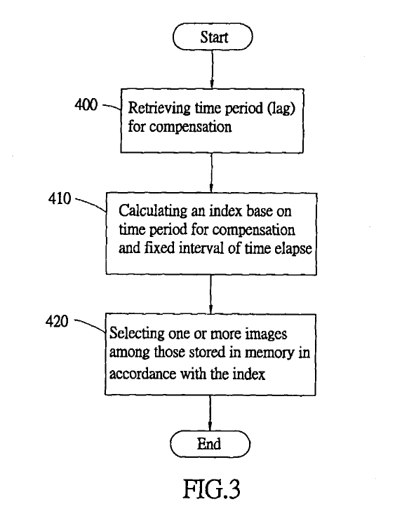

FIG. 3 shows a flow chart of an illustrative, but not limitative, process of determination of the image to be kept in the buffer memory 30. The determination is generally done by first retrieving or accessing the time period for compensation or the photographer's lag, step 400. An index can then be calculated based on the time period for compensation and the time interval at which images are taken, step 410. For example, a division of the time period for compensation by the time interval gives a number and a Gaussian operation of the number gives an integer that indicates the image or the next image that is closest in time to the moment the photographer wished to take picture. The desired image can thus be determined and selected, step 420.

As a variation of the method of the present invention, more than one image can be selected in step 420 and stored in the long-term storage 60 of the camera. Instead of selecting only the image closest in time to the photographer's lag prior to the indication to capture a final image, the processor unit 40 selects two, three or more images closest to this time for further processing and saving the images in the long-term storage 60. The size of the buffer memory 30 and the number of images stored in the buffer memory 30 would have to grow to ensure that all possibly required images remain in the buffer memory 30 when final selection of the images is made. This modified process results in several images stored but increases the likelihood that an image in the long-term storage 60 was captured very close to the photographer's desired moment in time.

While the best mode and alternatives thereof have been described to illustrate the present invention, it is not the inventor's intention to limit in any way the scope of the included claims to the details of the embodiments described. For example, a two-stage shutter release need not be used. Two separate buttons, or one button pressed twice, or any other means achieving the same result could be used. Also, the images stored in the buffer need not be completely unprocessed. If the processor is fast enough, the images could be processed the same as any final image for the camera and the “buffer” could be located physically in the long-term storage. Additional advantages and modifications will readily appear to those skilled in the art.

What is claimed is:

1. A method of compensating for delay inherent in an electronic still imaging apparatus employing digital processing of image signals corresponding to a still image and storage of the processed image signals in a long-term digital memory, said imaging apparatus including an area image sensor having a two-dimensional array of photosites corresponding to picture elements of the image and means for exposing said sensor to image light and converting said image light so that digital image information is generated for each photosite, the method comprising the following steps:
(1) digitally capturing a collection of images at substantially regular intervals and storing the images in a buffer memory;
(2) manually indicating a moment in time to capture;
(3) determining and selecting among the images in the buffer memory at least one image to be kept that corresponds most closely in time to a predetermined amount of time prior to said manual indication;
(4) removing all but the selected image from the buffer memory; and
(5) selectively processing and moving and storing the selected image in the long-term memory.

2. The method as claimed in claim 1, wherein step (1) further comprises the following steps:
(a) capturing an image;
(b) writing the captured image into the buffer memory if number of images stored in the buffer memory does not exceed a predetermined maximum and going to step (d);
(c) otherwise removing an oldest one of the images stored in the buffer memory from the buffer memory and writing the captured image into the buffer memory; and
(d) after the regular interval, repeating steps (a) to (d) to capture and store a next image at the regular intervals.

3. The method as claimed in claim 1, wherein step (3) further comprises the following steps:
(e) calculating an index based on the predetermined amount of time and the regular time interval; and
(f) determining the image to be kept in accordance with the index.

4. The method as claimed in claim 1, wherein the calculation of step (e) comprises division of the predetermined amount of time by the regular time interval.

5. The method as claimed in claim 1, wherein the predetermined amount of time is based on typical reaction time of human.

6. The method as claimed in claim 1, wherein the buffer memory is part of the long-term storage.

7. The method as claimed in claim 1, wherein the regular time intervals depend upon the magnitude of the predetermined amount of time.

8. The method as claimed in claim 2 further comprising a step of selecting optic settings for the electronic still imaging apparatus before step (1) and wherein step (d) further comprises a step of changing the optic settings before the next image is captured.

9. A method of compensating for delay inherent in an electronic still imaging apparatus employing digital processing of image signals corresponding to a still image and storage of the processed image signals in a long-term digital memory, said imaging apparatus including an area image sensor having a two-dimensional array of photosites corresponding to picture elements of the image and means for exposing said sensor to image light and converting said image light so that digital image information is generated for each photosite, the method comprising the following steps:
(1) digitally capturing a collection of images at substantially regular intervals whereby the images cover a span of time;
(2) manually indicating a moment in time to capture within the span of time;
(3) determining and selecting among the collection of images at least one image to be kept that corresponds most closely in time to a predetermined amount of time prior to said manual indication; and
(4) storing the selected image in the long-term memory.

10. The method as claimed in claim 9 further comprising a step of indication of starting capturing of the collection of the image.

11. The method as claimed in claim 9, wherein the predetermined amount of time is based on typical reaction times of humans.

12. The method as claimed in claim 9, wherein the collection of stored images comprises unprocessed raw digital images.

13. The method as claimed in claim 9 further comprising a step of storing the regularly captured images in a buffer memory.

14. The method as claimed in claim 9, wherein the span of time is greater than a reaction time of human.

15. The method as claimed in claim 9, wherein step (1) further comprises the following steps:
(a) capturing an image;
(b) writing the captured image into a buffer memory if number of images stored in the buffer memory does not exceed a predetermined maximum and going to step (d);
(c) otherwise removing an oldest one of the images stored in the buffer memory from the buffer memory and writing the captured image into the buffer memory; and
(d) after the regular interval, repeating steps (a) to (d) to capture and store a next image at the regular interval.

16. The method as claimed in claim 9 further comprising a step of deleting all of the images in the collection except for the selected image.

17. A method of compensating for delay inherent in an electronic still imaging apparatus employing digital processing of image signals corresponding to a still image and storage of the processed image signals in a long-term digital memory, said imaging apparatus including an area image sensor having a two-dimensional array of photosites corresponding to picture elements of the image and means for exposing said sensor to image light and converting said image light so that digital image information is generated for each photosite, the method comprising the following steps:
(1) digitally capturing a collection of properly exposed, in focus images at substantially regular intervals, the collection of images covering a span of time;
(2) storing said digital images in an image buffer;
(3) manually indicating an intension to capture an image;
(4) selecting an image in said buffer that corresponds most closely in time to the point in time a predetermined amount of time prior to said indication to capture the image;
(5) processing said selected image from the buffer to obtain a digital color image; and
(6) storing the digital color image in the long-term storage.

18. The method as claimed in claim 17 further comprising a step of manually indicating when to start capturing said regularly captured images before step (1).

19. The method as claimed in claim 17, wherein said predetermined amount of time is based on typical reaction time of humans.

20. The method as claimed in claim 17, wherein the span of time is greater than the predetermined amount of time.

21. The method as claimed in claim 17, wherein step (1) further comprises the following steps:
(a) capturing a new image;
(b) writing the captured new image into the buffer memory if number of images stored in the buffer memory does not exceed a predetermined maximum and going to step (d);
(c) otherwise removing an oldest one of the images stored in the buffer memory from the buffer memory and writing the captured new image into the buffer memory; and
(d) after the regular interval, repeating steps (a) to (d) to capture and store a next image at the regular interval;
wherein the predetermined maximum is such that ensures at least one image captured more than the predetermined amount of time prior to the captured new image remains in the buffer memory.

22. The method as claimed in claim 17 further comprising a step of deleting all of the images in the buffer memory except for the image selected for further processing and storage.

23. A method for compensating delay inherent in an electronic still imaging apparatus employing digital processing of image signals corresponding to a still image and storage of the processed image signals in a long-term digital memory, said imaging apparatus including an area image sensor having a two-dimensional array of photosites corresponding to picture elements of the image and means for exposing said sensor to image light and converting said image light so that digital image information is generated for each photosite, the method comprising the following steps:
(1) digitally capturing a collection of properly exposed, in focus images at substantially regular intervals, the collection of images covering a span of time;
(2) processing and storing each image of the collection to the long-term storage before a next mage of the collection is captured;
(3) manually indicating an intention for permanently capturing an image;
(4) selecting at least one of the images in the long-term storage that corresponds most closely in time to a predetermined amount of time prior to said indication; and
(5) deleting all images from long-term storage other than the selected image.

24. The method as claimed in claim 23, wherein said predetermined amount of time is based on typical reaction time of humans.
